(19) United States
(12) Patent Application Publication
(10) Pub. No.: US 2014/0121947 A1
(43) Pub. Date: May 1, 2014

(54) ENGINE CONTROL UNIT

(71) Applicant: Atsushi Komuro, Hitachinaka (JP)

(72) Inventor: Atsushi Komuro, Hitachinaka (JP)

(73) Assignee: Hitachi Automotive Systems, Ltd.

(21) Appl. No.: 14/126,139

(22) PCT Filed: Jun. 14, 2012
(86) PCT No.: PCT/JP2012/065208

§ 371 Date: Dec. 13, 2013

(30) Foreign Application Priority Data
Jun. 17, 2011 (JP) 2011-135268

(51) Int. Cl. F02D 28/00

(52) U.S. Cl. CPC F02D 28/00
USPC 701/103

(57) ABSTRACT

Engine control unit enabling to learn a change of relationship between a throttle opening degree and an intake air quantity (opening degree—air quantity characteristic) while restricting lowering of fuel efficiency to a minimum and to improve accuracy of engine stall prevention, torque control, including: a learning means which learns a characteristic change amount of the opening degree—air quantity characteristic; a learning requirement determining means; and a learning moving means causing executing learning in a stable driving state. The learning requirement determining means derives a separation amount between an intake air quantity corresponding to a throttle valve opening degree at present time and an actual intake air quantity detected in the stable driving state and determines requirement of learning with use of the separation amount and a threshold value.

### TECHNICAL FIELD

The present invention relates to an engine control unit and more specifically relates to a control unit adapted to learn a change of an engine characteristic such as relationship between an opening degree of a throttle valve and an intake air quantity (hereinafter referred to as an opening degree—air quantity characteristic) of an engine adapted to perform an idle stop, in which the engine is temporarily stopped, when a driving state of the engine and a vehicle mounting the same satisfies a predetermined condition.

### BACKGROUND ART

In a technical field of automobiles is known a technique in which, when a state of an engine and a vehicle mounting the same such as a state of waiting at a stoplight satisfies a predetermined condition, an idle stop, in which an engine is temporarily stopped, is performed, and in which the engine is thereafter restarted when an accelerator operation by a driver is performed, for the purpose of improvement in fuel efficiency, reduction in greenhouse gas emissions, and the like.

Also, in a hybrid vehicle including both a motor (motor generator) and an engine as travel driving sources is known a technique in which, in a case where a driver's demanded driving force is a predetermined value or less while power-generating driving for battery charge is not required during travel, the engine functioning as a travel driving source until then is stopped, and when the driver's demanded driving force is a predetermined value or more (for example, when it is motor generating torque or more), or when battery charge is determined to be required, an engine output shaft (crankshaft) is supplied with torque to restart the engine.

In other words, while the engine continues idle driving even in a scene in which the driver does not perform the accelerator operation in an earlier vehicle, unnecessary idle driving is not performed for improvement in fuel efficiency and emission performance in a vehicle adapted to perform the idle stop such as the hybrid vehicle.

In general, in the idle driving state, so-to-speak idle speed control (ISC), in which feedback control is performed so that engine revolution speed may settle in and correspond to target engine revolution speed, is performed. Since a driving state is stable during execution of this idle speed control, various kinds of learning are performed to absorb individual differences and aging degradation of the engine (for example, refer to PTL 1).

As one of learning kinds, there is learning (characteristic) of relationship between an opening degree of an electronic throttle control valve (hereinafter referred to as a throttle opening degree) and an intake air quantity.

More specifically, in a control system of the electronic throttle control valve provided in the in-vehicle engine, the relationship between the throttle opening degree and the intake air quantity (opening degree—air quantity characteristic) previously derived by an experiment or the like is normally stored in a storage device in a control unit in the form of a table or a map, for example. At the time of engine driving, a target intake air quantity is set based on an accelerator operation amount, and a throttle opening degree demanded at the time is calculated based on the stored opening degree—air quantity characteristic so that an actual intake air quantity (intake air quantity detected by an air flow sensor) may be the target intake air quantity. (A valving element of) the throttle valve is turned by an actuator such as a motor to obtain the calculated throttle opening degree.

Since the opening degree—air quantity characteristic differs and changes with individual differences and aging degradation of the engine including the electronic throttle control valve, feedback control, in which the throttle opening degree is increased or decreased with use of the intake air quantity detected by the air flow sensor, the target intake air quantity, and the like, is performed at the time of idle driving to learn a change amount (gap) of the opening degree—air quantity characteristic, and the stored opening degree—air quantity characteristic is corrected with use of the characteristic change amount (learned value) obtained by the learning, for example.

Also, since the opening degree—air quantity characteristic changes (in general, in a direction in which the intake air quantity decreases against the throttle opening degree) as well by adhesion of gummy foreign matters (hereinafter referred to as deposits) at a part of the throttle valve in an air intake passage caused by mixing of blow-by gas, the characteristic change amount needs to be learned periodically to correct the opening degree—air quantity characteristic.

Also, since phase delay by air intake pipe volume is generated in the intake air quantity detected by the air flow sensor in a transient state in which the engine revolution speed and load change, the learning is normally performed when the engine is in a stable driving state, that is, at the time of idle driving from a viewpoint of securement of correlation with the throttle opening degree.

Meanwhile, the relationship between the throttle opening degree and the intake air quantity is normally used as the opening degree—air quantity characteristic, but instead, relationship between the throttle opening degree and an effective passage cross-sectional area of the part of the throttle valve in the air intake passage (hereinafter referred to as a throttle opening area) is used in some cases.

However, in the vehicle adapted to perform the idle stop as described above, the idle driving state does not exist basically, and thus an opportunity for the learning cannot be secured.

Under such circumstances is known prohibiting the idle stop at the time of traveling a predetermined distance or performing KEYON predetermined times and performing the learning. However, in this case, the idle stop is prohibited even in a case where no learning is required, which causes lowering of fuel efficiency, and at the time of traveling in an area in which deposit adhesion easily increases, a learning frequency is not sufficient, which may generate engine stall and torque deviation.

To avoid such circumstances, PTL 1 proposes learning in a non-idle driving state.

### CITATION LIST

### Patent Literature

PTL 1: JP 2010-65529 A

### SUMMARY OF INVENTION

### Technical Problem

In general, in the hybrid vehicle, since the engine is controlled to keep an optimum fuel efficiency line, the stable driving state exists even in the non-idle driving state.

However, PTL 1 does not describe the stable driving state. Accordingly, learning is performed even in a transient state at the time of the non-idle driving, and learning accuracy may be lowered.

The present invention is accomplished by taking such circumstances as mentioned above into consideration thereof, and an object thereof is to provide an engine control unit enabling to raise learning accuracy while restricting lowering of fuel efficiency to a minimum and to improve accuracy of engine stall prevention, torque control, and the like in a state where an idle stop, in which an engine is temporarily stopped, is adapted to be performed when a driving state of the engine and a vehicle mounting the same satisfies a predetermined condition and in a state where a change of an engine characteristic such as relationship between a throttle opening degree and an intake air quantity (opening degree—air quantity characteristic) is adapted to be learned.

### Solution to Problem

To achieve the above object, an engine control unit according to the present invention is configured to include a learning means which learns a characteristic change amount of an engine characteristic such as a throttle opening degree—air quantity characteristic to correct a previous characteristic, a stable driving state determining means which determines whether or not a vehicle is in a stable driving state at time of non-idle driving, a learning requirement determining means which determines requirement of the learning when it is determined by the means that the vehicle is in the stable driving state, and a learning moving means which causes the vehicle to move onto the stable driving state such as an idle driving state and causes the learning means to execute the learning when it is determined by the determining means that the learning is required.

### Advantageous Effects of Invention

In a case of normal control, in which learning is performed in the idle driving state, learning requirement determination is not performed, and learning is performed every time the vehicle becomes in the idle driving state by accident. Thus, in a case where the vehicle is one that rarely becomes in the idle driving, learning cannot be performed, and determination of whether or not learning is required cannot be performed.

Under such circumstances, by providing the learning requirement determining means as described above and performing the learning requirement determination in the stable driving state at the time of the non-idle driving, learning requirement can be determined even in a hybrid vehicle with almost no idle driving state.

By doing so, in the hybrid vehicle, for example, in a case where it is determined that learning is required, an idle stop can be prohibited, the vehicle can move onto the idle driving, and learning can be performed. That is, since transition to the idle driving can be performed only in a scene requiring learning, lowering of fuel efficiency can be restricted to a minimum. Also, learning accuracy can be raised while restricting lowering of fuel efficiency to a minimum, and accuracy of engine stall prevention, torque control, and the like can be improved.

Other problems, configurations, and effects than the aforementioned ones become obvious by the following embodiments.

### BRIEF DESCRIPTION OF DRAWINGS

FIG. 1 is a schematic configuration diagram illustrating an embodiment of an engine control unit according to the present invention as well as an engine for a hybrid vehicle to which the engine control unit has been applied.

FIG. 2 illustrates a configuration on the periphery of an ECU constituting a main part of the engine control unit according to the present invention.

FIG. 3 is a block diagram for use in description of a calculation example of a target throttle opening degree.

FIG. 4 is a correlation diagram illustrating an example of relationship among target torque, a throttle opening area (intake air quantity), and a throttle opening degree.

FIG. 5 is a flowchart illustrating an example of a processing procedure at the time of performing requirement determination of learning of a change amount of an opening degree—air quantity characteristic in a first embodiment of the present invention.

FIG. 6 is a flowchart illustrating a detailed processing procedure example for calculation of a separation amount in S106 in FIG. 5.

FIG. 7 is a view for use in description of requirement determination of learning of the change amount of the opening degree—air quantity characteristic.

FIG. 8 is a timing chart illustrating operations and changes of respective units around requirement determination of learning of the change amount of the opening degree—air quantity characteristic and learning and correction.

FIG. 9 is a flowchart illustrating an example of a processing procedure at the time of performing requirement determination of learning of a change amount of an opening degree—air quantity characteristic in a second embodiment of the present invention.

FIG. 10 is a graph illustrating a frequency at which learning requirement determination has been performed per throttle opening degree.

### DESCRIPTION OF EMBODIMENTS

Hereinafter, embodiments of the present invention will be described with reference to the drawings.

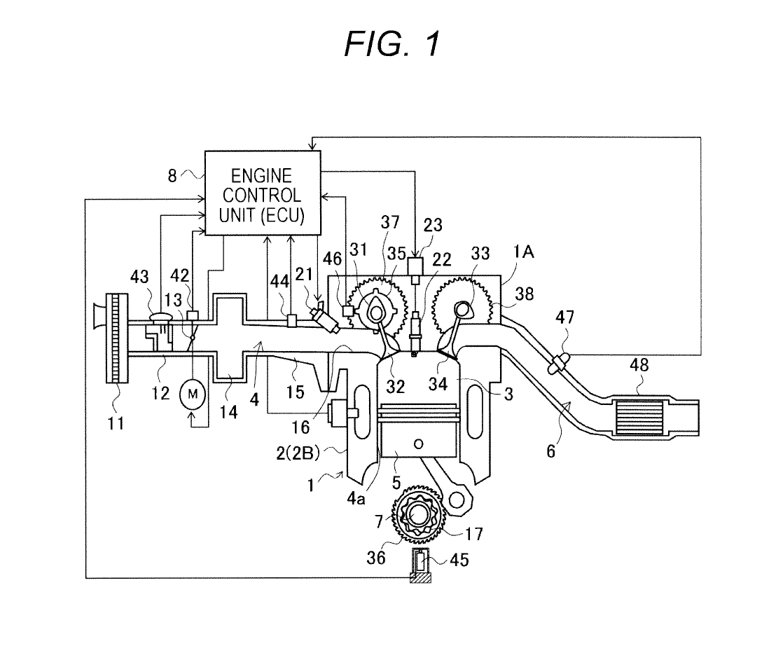

FIG. 1 is a schematic configuration diagram illustrating an embodiment of an engine control unit according to the present invention as well as an engine for a hybrid vehicle to which the engine control unit has been applied.

An engine 1 illustrated in the figure is a DOHC-type multiple cylinder four-cycle engine and includes a cylinder 2 including a cylinder head 2A and a cylinder block 2B, the cylinder head 2A is provided with a cam shaft 31 for an air intake valve 32 and a cam shaft 33 for an air exhaust valve 34, in the cylinder block 2B is slidably fitted and inserted a piston 5, on an upper side of the piston 5 is defined a combustion operating chamber 3 having a combustion chamber (a ceiling or a roof portion) formed in a predetermined shape, and this combustion operating chamber 3 faces an ignition plug 22 connected to an ignition unit 23 constituted by an ignition coil and the like.

Air for use in fuel combustion is supplied from an air cleaner 11, passes through an air intake passage 4 including a throttle body (tubular passage portion) 12 in which an air flow sensor 43 of a hot wire type or the like and an electronic throttle control valve 13 are arranged, a collector 14, an air intake manifold (manifold) 15, an air intake port 16, and the like, and is sucked into the combustion operating chamber 3 of each cylinder via the air intake valve 32 arranged at a downstream end of the air intake passage 4 (end portion of the air intake port 16). Also, a downstream portion (air intake manifold 15) of the air intake passage 4 faces a fuel injection valve 21 injecting fuel toward the air intake port 16 and is provided with an air intake pressure sensor 44. To the throttle body 12 is attached a throttle (opening degree) sensor 42 detecting an opening degree of the electronic throttle control valve 13.

A crank pulley 36 is attached and fixed to one end of a crankshaft 7, an air intake cam pulley 37 is externally fitted and fixed on one end of the air intake cam shaft 31 adapted to open and close the air intake valve 32, and an air exhaust cam pulley 38 is externally fitted and fixed on one end of the air exhaust cam shaft 33 adapted to open and close the air exhaust valve 34. The respective pulleys 36, 37, and 38 are provided on outer circumferential portions thereof with teeth and have a timing belt (not illustrated) hung therearound, and a revolution of the crankshaft 7 is transmitted to the air intake cam shaft 31 and the air exhaust cam shaft 33 by this timing belt. Meanwhile, a revolution speed ratio of the air intake cam pulley 37 or the air exhaust cam pulley 38 to the crank cam pulley 36 is 1:2.

Mixture gas of air sucked in the combustion operating chamber 3 and fuel injected from the fuel injection valve 21 is combusted by spark ignition by the ignition plug 22, and combustion exhaust gas (emissions) is supplied from the combustion operating chamber 3 via the air exhaust valve 34 to an air exhaust passage 6 including an air exhaust port, an air exhaust manifold, an air exhaust pipe provided with an exhaust air cleaning catalyst (for example, a ternary catalyst) 48, and the like and is exhausted to an outside (to the atmosphere). On a further upstream side than the catalyst 48 in the air exhaust passage 6 is provided an oxygen concentration sensor (air-fuel ratio sensor) 47.

Also, the fuel injection valve 21 installed per cylinder is supplied with fuel (gasoline or the like) in a fuel tank whose fuel pressure is adjusted to predetermined pressure by a fuel supply mechanism including a fuel pump rotary-driven by the crankshaft 7, a fuel pressure regulator, and the like, is driven to be opened by a driving pulse signal having a pulse width (corresponding to valve opening time) in accordance with an operating state at the time supplied from an engine control unit (hereinafter referred to as an ECU) 8 constituting a main part of the engine control unit according to the present embodiment, and injects fuel having an amount corresponding to the valve opening time toward the air intake port 16.

Also, the engine 1 is equipped with a water temperature sensor 41 detecting a temperature of engine cooling water, a crank angle sensor 45 detecting a revolution angle of (a toothed circular plate fixed to) the crankshaft 7 to output an angle signal representing a revolution position of the crankshaft 7, a cam angle sensor detecting a revolution angle of (a toothed circular plate 35 fixed to) the cam shaft 31 driving the air intake valve 32 to output an angle signal representing a revolution position of the cam shaft 31, and the like, and signals obtained from these are supplied to the ECU 8.

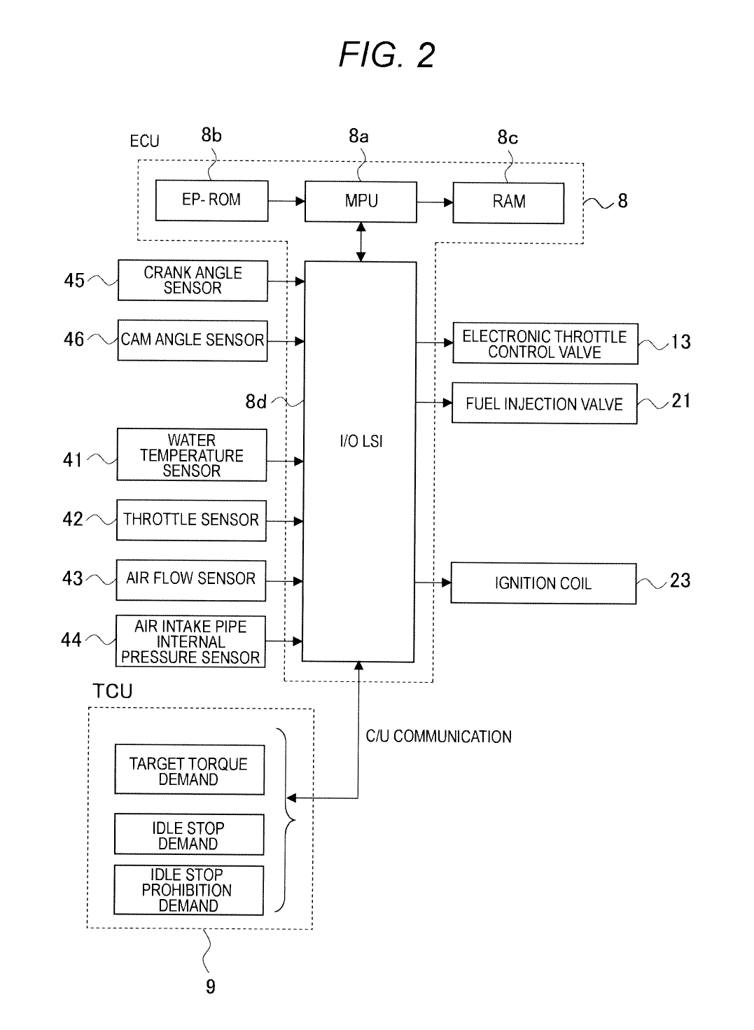

As for the ECU 8 according to the present embodiment, hardware thereof is well known, and a main part thereof is constituted by an MPU 8a, an EP-ROM 8b, a RAM 8c, an I/O LSI 8d including an A/D converter, and the like, as illustrated in FIG. 2.

To an input side of the I/O LSI 8d are supplied signals from various sensors such as the crank angle sensor 45, the cam angle sensor 46, the water temperature sensor 41, the throttle sensor 42, the air flow sensor 43, the air intake pipe internal pressure sensor 44, and the air-fuel ratio sensor 47.

Also, a hybrid vehicle to which the engine control unit 8 according to the present embodiment is applied has a consolidated control unit (hereinafter referred to as a TCU) 9 incorporating a microcomputer separately from the ECU 8, and data transmission and reception are performed between the TCU 9 and the ECU 8 by an inter-unit communication such as a CAN communication, such as transmission of a target torque demand, which should be achieved, an idle stop demand, which temporarily stops the engine, an idle stop prohibition demand, which prohibits the idle stop, and the like from the TCU 9 to the ECU 8.

The ECU 8 executes predetermined calculation processing based on these input signals and inter-unit communication signals, outputs from the I/O LSI 8d various control signals derived as a result of this calculation, and supplies predetermined control signals to the electronic throttle control valve 13, the fuel injection valve 21, the ignition coil 23, and the like as actuators to execute throttle opening degree control, fuel injection control, ignition timing control, and the like.

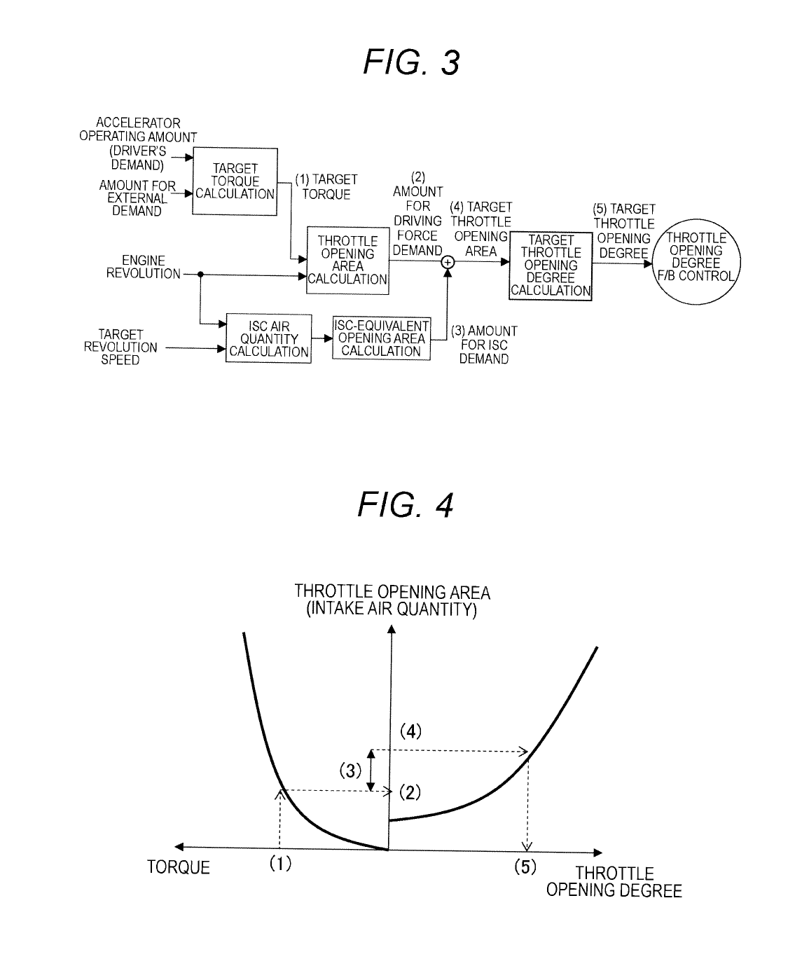

Next, control related to learning of a change amount of an opening degree—intake air quantity characteristic (opening degree—air quantity characteristic) of the throttle valve 13 will be described with reference to a block diagram in FIG. 3 and a graph in FIG. 4.

First, target torque (1) is calculated based on demanded torque from the TCU 9 including demanded torque by a driver's accelerator operation and external demanded torque. From the calculated target torque (1), a throttle opening area (corresponding to the intake air quantity) (2) as an amount for a driving force demand unambiguously derived in accordance with an engine characteristic is calculated.

Separately from this, an engine revolution speed holding amount when the accelerator is off, so to speak, in an idle driving state, is calculated from target revolution speed and actual engine revolution speed as an ISC control air quantity, and an ISC-equivalent opening area (3) is calculated in a similar manner to the opening area as the amount for a torque demand. The opening area as the amount for the driving force demand (2) and the ISC-equivalent opening area (3) are added to derive a throttle opening area (4) required for a current driving state. This throttle opening area (4) corresponds to the intake air quantity required for the current driving state.

Subsequently, since the intake air quantity, the throttle opening area, and the throttle opening degree correlate with one another, a throttle opening degree corresponding to the target throttle opening area (4) is read out from a map representing a throttle opening degree/throttle opening area characteristic (referred to as an opening degree—air quantity characteristic in a similar manner to that in the case of the aforementioned throttle opening degree—intake air quantity characteristic) stored in a storage device (EP-ROM 8b) in advance to derive a final target throttle opening degree (5), and (a valve body of) the throttle valve 13 is controlled to be turned so as to have the derived opening degree (5), for example.

However, there is a case in which, due to aging variation such as deposit adhesion, an actual throttle opening area (intake air quantity) does not correspond to the aforementioned (4) even when a throttle opening degree is set to the aforementioned (5), in which excess and deficiency occur in the intake air quantity, and in which required torque cannot be obtained.

More specifically, since the opening degree—air quantity characteristic stored in the storage device in advance is an initial characteristic, an actual opening degree—air quantity characteristic changes from the initial opening degree—air quantity characteristic due to aging variation such as deposit adhesion. When this change is significant, the throttle opening degree derived with use of the initial opening degree—air quantity characteristic will cause excess and deficiency in the intake air quantity. In other words, for example, when the deposit adhesion occurs, the throttle opening area will be small, and in order to obtain the target intake air quantity to be set in accordance with the accelerator operating amount and the like, the throttle opening degree needs to be enlarged.

Meanwhile, in FIG. 3, in the hybrid vehicle, since the target torque that the engine should achieve is calculated by the consolidated control unit, a target torque demand from the consolidated control unit is used instead of the accelerator opening degree at the time of calculation of the target torque (1).

As described above, a change of the opening degree—air quantity characteristic due to ageing variation such as deposit adhesion needs to be corrected by learning, and since phase delay by air intake pipe volume is generated, learning of (the change of) the opening degree—air quantity characteristic is normally performed in an idle driving state, in which a driving state is stable. However, as described above, since an idle driving point does not exist basically in the vehicle having an idle stop function, the learning cannot be performed.

Under such circumstances, in the first embodiment, whether or not the vehicle is in a stable driving state is determined at the time of non-idle driving. In a case where the vehicle is in the stable driving state, whether or not learning is required is determined. In a case where the learning is required, an idle stop is prohibited to make an idle driving state for the learning, and a characteristic change amount of an opening degree—air quantity characteristic representing relationship between an opening degree of the throttle valve 13 and an intake air quantity stored in a characteristic storing means (EP-ROM 8b) of the ECU 8 is learned to correct the previous characteristic stored in the characteristic storing means. The ECU 8 controls the throttle valve 13 with use of a latest opening degree—air quantity characteristic stored in the characteristic storing means.

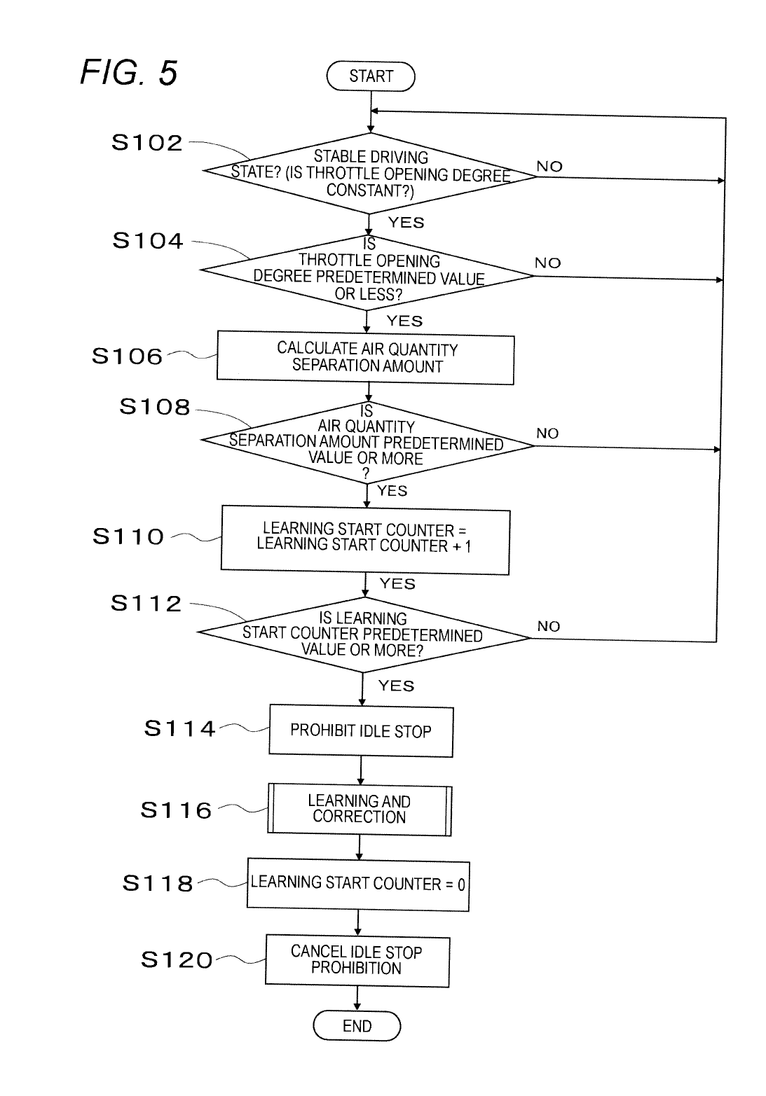

Hereinafter, this will be described in details with reference to a flowchart in FIG. 5.

First, in step S102 (hereinafter, “step” will be omitted), whether or not the vehicle is in a stable driving state is determined. Here, whether or not the vehicle is in the stable driving state is determined by whether or not a throttle opening degree is constant (whether or not the opening degree changes). When the throttle opening degree is constant, the vehicle is basically in a steady state even in a case where slight air phase delay exists. Additionally, conditions in which a change of the engine revolution speed is a predetermined value or less, in which a change of the intake air quantity is a predetermined value or less, in which a change of the air intake pressure is a predetermined value or less, and the like may be added. Also, warm-up driving, power generation driving, and the like can be regarded as stable driving states since they satisfy the aforementioned conditions. That is, in a case where, at the time of non-idle driving, at least one out of the opening degree of the throttle valve, the engine revolution speed, and the actual intake air quantity is continuously in a predetermined range for a predetermined period or more, it is determined that the vehicle is in the stable driving state.

In a case where it is determined in S102 that the vehicle is not in the stable driving state, the procedure returns to the start and stands by until the vehicle becomes in the stable driving state. In a case where the stable driving state is started, the procedure goes to S104, and whether or not the throttle opening degree is a predetermined value or less is determined. In general, an influence of a change of the opening degree—air quantity characteristic due to deposit adhesion becomes obvious at a low throttle opening degree and is hardly obvious at a high throttle opening degree. Thus, the following processing is executed only in a case where the throttle opening degree is low. A threshold value for use in determination in S104 is derived in advance from an opening degree at a frequency that can occur in the hybrid vehicle and an opening degree in which the influence of the change of the opening degree—air quantity characteristic becomes obvious.

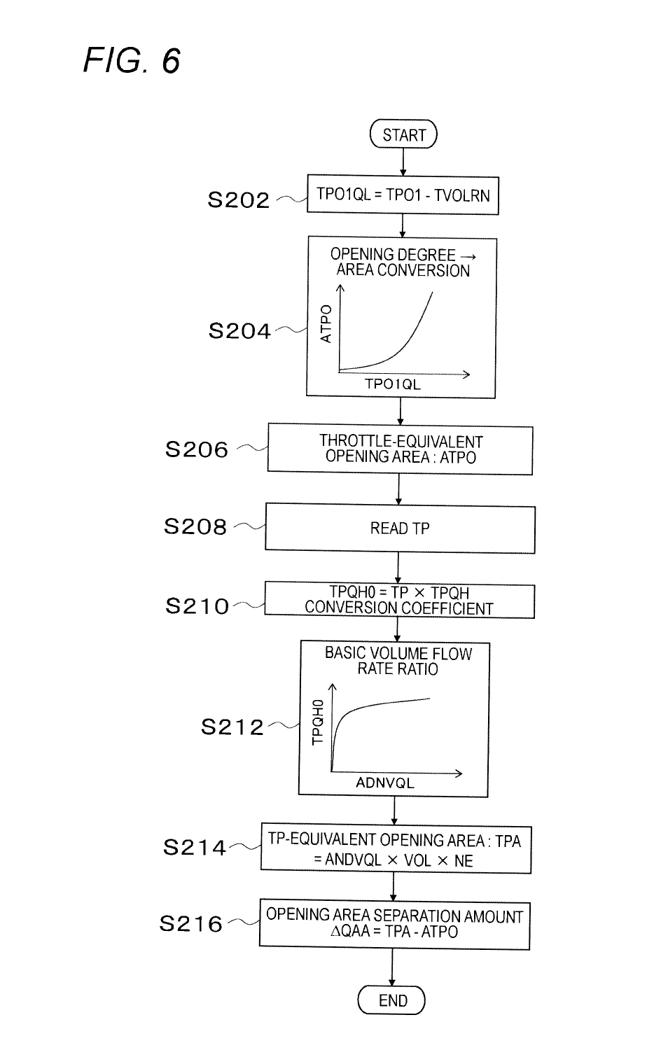

In a case where the throttle opening degree is the threshold value (predetermined value) or less, the procedure goes to S106, and a change amount of the opening degree—air quantity characteristic is derived. Here, to derive the change amount of the opening degree—air quantity characteristic, a difference between an opening area derived from the throttle opening degree detected by the throttle sensor 42 and an opening area derived from an air quantity detected by the air flow sensor 43 is calculated as an air quantity separation amount. This will be described in details below with reference to FIG. 6.

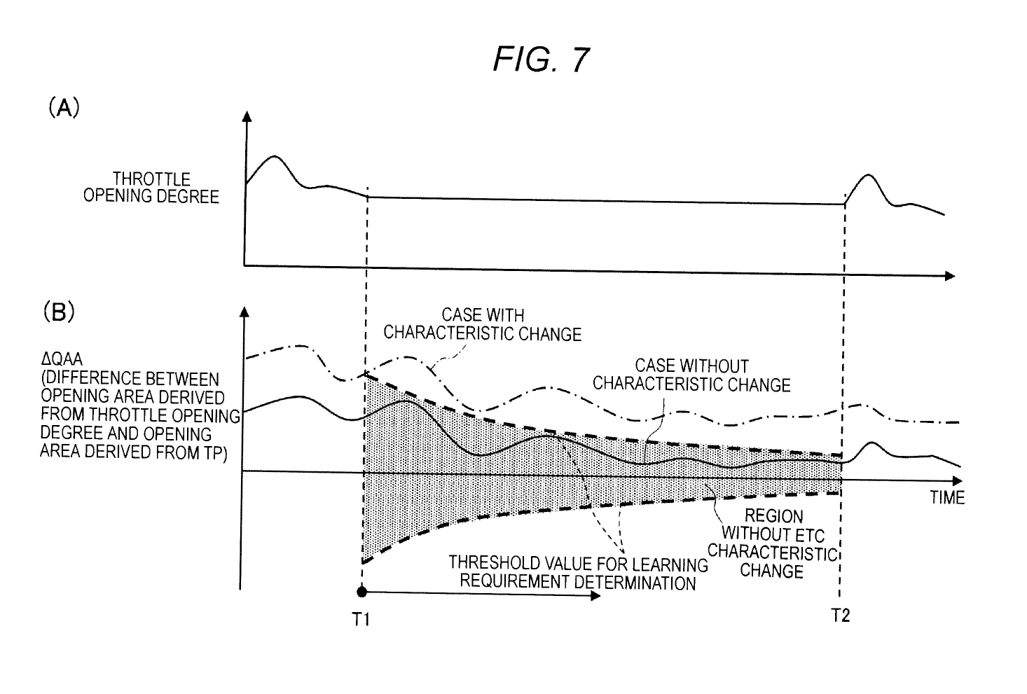

In S108, whether or not the air quantity separation amount calculated in S106 is a predetermined value (threshold value) or more is determined. In a case where it is the predetermined value or more, this means that the air quantity is separated, that is, the opening degree—air quantity characteristic changes, and the procedure goes to S110, in which a learning start counter is incremented by one. In a case the amount is less than the predetermined value, this means that the opening degree—air quantity characteristic does not change, and the procedure returns to the start. A configuration in which the learning start counter is cleared when the procedure returns to the start and is counted up only when a state in which the air quantity separation amount is the predetermined value or more is repeated may be available. The threshold value determining whether or not the opening degree—air quantity characteristic changes will be described below with reference to FIG. 7.

In S112, whether or not the learning start counter (cumulative count for the separation amount to exceed the threshold value) is a predetermined value or more is determined. This means that the change of the opening degree—air quantity characteristic is detected plural times. This is done to prevent erroneous determination since the magnitude of the separation amount is determined in a non-idle driving state.

In a case where the learning start counter is the predetermined value or more, the procedure goes to S114, and an idle stop prohibition demand is transmitted to the TCU 9. The TCU 9 considers states of the motor and the engine and moves the vehicle to the idle driving state in a case where there is no engine torque demand. In this idle driving state, learning and correction is performed in S116, in which so-to-speak idle speed control (ISC) is performed to derive a change amount (learning value) of the opening degree—air quantity characteristic, and in which the stored opening degree—air quantity characteristic is corrected with use of the characteristic change amount (learning value) (this learning and correction is well known in this technical field, and thus detailed description thereof is omitted).

After the learning and correction is finished, the procedure goes to S118 to clear the learning start counter, cancellation of the idle stop prohibition demand is transmitted to the TCU 9 in S120, and the engine is stopped (the IG switch is off).

Next, calculation of the air quantity separation amount performed in S104 in FIG. 5 will be described with use of a flowchart in FIG. 6.

Although calculation of the air quantity separation amount herein is a method by converting the air quantity into a dimension of opening area information, conversion into a dimension of throttle opening degree information and a dimension of air quantity information may be available.

In S202, a learning value TVOFQL (an initial value is zero) as a previous characteristic change amount is subtracted from a throttle opening degree TPO1 detected by the throttle sensor 42 to calculate a corrected throttle opening degree TPO1QL. That is, a throttle opening degree in a state of no learning acts as a reference value.

In S204, the corrected throttle opening degree TPO1QL is converted into a throttle opening degree equivalent opening area ATPO1 with use of an opening degree—area conversion table.

On the other hand, in S208, a mass flow rate TP detected by the air flow sensor 43 is read. In S210, the mass flow rate TP is multiplied by a mass flow rate→volume flow rate conversion coefficient TPQH in a reference state (standard state) to calculate a volume flow rate ratio TPQH0 in the reference state.

In S212, an opening area/suction volume equivalent ADNVQL is calculated from the volume flow rate ratio TPQH0 with use of a volume flow rate ratio—opening area/suction volume equivalent conversion table. Meanwhile, in the volume flow rate ratio—area/suction volume equivalent conversion table, in a region in which the throttle opening area is small, the flow is sonic flow, and the volume flow rate increases in proportion to an increase of the opening area, but in a region in which the opening area is large, the volume flow rate has a characteristic of getting close to a saturated state.

In S214, the opening area/suction volume equivalent ADNVQL is multiplied by an engine displacement VOL and engine revolution speed NE to calculate a TP-equivalent opening area TPA.

In S216, a difference between the throttle-equivalent opening area ATPO derived in S206 and the TP-equivalent opening area TPA derived in S214 is derived to calculate an opening area separation amount ΔQAA.

Although ΔQAA is approximately zero in a case where there is no change in the opening degree—air quantity characteristic, the ΔQAA value is larger as a change of the opening degree—air quantity characteristic is more significant. That is, in a case where the ΔQAA value is large, this can mean that the opening degree—air quantity characteristic has been changed significantly.

Next, determination of whether or not the opening degree—air quantity characteristic has changed significantly (learning requirement determination) will be described with reference to FIG. 7.

In a case where the opening area separation amount ΔQAA is a predetermined value or more, it is possible to determine that the opening degree—air quantity characteristic has changed significantly. However, the present embodiment adopts a configuration in which calculation of the opening area separation amount is started after the throttle opening degree becomes constant as a stable driving state. Accordingly, immediately after the throttle opening degree becomes constant to obtain the stable driving state, it takes time until the air quantity becomes constant due to phase delay of the air intake system. During the period, since the air intake system in a previous driving state has an influence, the opening area separation amount deviates and exceeds a threshold value, which may cause erroneous determination even in a case where the opening degree—air quantity characteristic does not change much. On the other hand, in a case where calculation is started after obtaining a state in which the air quantity is constant, it will take time for characteristic change determination.

Since the hybrid vehicle is in the non-idle driving state while keeping an optimum fuel efficiency line, the stable driving state may be short, and thus a change of the opening degree—air quantity characteristic needs to be detected early. Under such circumstances, a configuration in which a threshold value for determination immediately after transition to the stable driving state is large, and in which the threshold value decreases as time goes by is adopted to achieve both early determination of whether or not the characteristic changes (learning requirement) and prevention of erroneous determination. Meanwhile, to further prevent erroneous determination, it is determined that the opening degree—air quantity characteristic has changed only in a case where the change of the opening degree—air quantity characteristic is detected plural times as in S108 to S112 in FIG. 5.

Also, since an influence of the characteristic change differs with the throttle opening degree, a configuration in which the threshold value is variable in accordance with the throttle opening degree may be added to the above configuration.

In FIG. 7, a solid line represents ΔQAA in a case where the opening degree—air quantity characteristic does not change while a dashed-dotted line represents ΔQAA in a case where the ETC characteristic changes. A dashed line represents a threshold value for determination of whether or not the opening degree—air quantity characteristic changes. In a case where ΔQAA exists in the dashed line, this means that the opening degree—air quantity characteristic does not change. As described above, this threshold value is set to decrease as time goes by.

At a time point T1, the throttle opening degree becomes constant, the vehicle moves onto the stable driving state, and calculation of the opening area separation amount is started. Immediately after the start, the value deviates significantly due to phase delay of the air intake system and gradually settles into a predetermined value. Even in a case where the opening degree—air quantity characteristic does not change as illustrated by the solid line, ΔQAA deviates significantly immediately after transition to the stable driving state. However, since the threshold value is set to be in a wide range at this time, erroneous determination does not occur. Final determination of the opening degree—air quantity characteristic change (learning requirement determination) is performed at a time point T2, at which the vehicle is out of the stable driving state.

As a matter of course, since erroneous detection is less likely to occur as the stable driving state continues longer, that is, as the period from the time point T1 to the time point T2 is longer, weighting of detection of the opening degree—air quantity characteristic change may be performed in accordance with duration time of the stable driving state. For example, a configuration in which an increment of the learning start counter in S110 in FIG. 5 is not fixed to one but is larger as the duration time of the stable driving state is longer may be available.

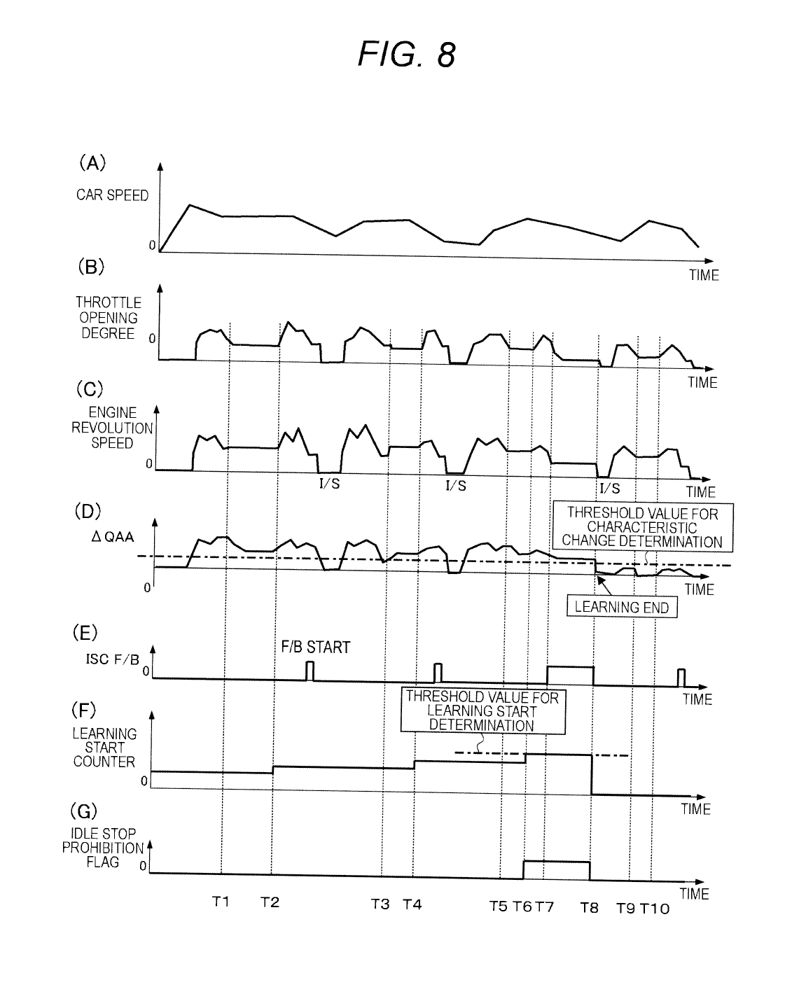

Next, operations and changes of the respective units in the present embodiment will be described with reference to a timing chart in FIG. 8.

In FIG. 8, the threshold value for determination of whether or not the opening degree—air quantity characteristic changes is a constant number for simplification (described in a timing chart of ΔQAA).

The vehicle is driven in a non-idle driving state and then becomes in a stable driving state at the time point T1, at which detection of the opening degree—air quantity characteristic change is started. At the time point T2, at which the vehicle becomes in a non-stable driving state, final determination of the opening degree—air quantity characteristic change is executed. Since the air quantity separation amount ΔQAA is larger than the threshold value for determination of whether or not the opening degree—air quantity characteristic changes (learning requirement determination), that is, since it is determined that the opening degree—air quantity characteristic changes, the learning start counter is incremented by one. Similarly, determination of the opening degree—air quantity characteristic change is executed in the stable driving state in the non-idle driving state (time points T3 to T4 and time points T5 to T6), and when the learning start counter exceeds the threshold value for learning start determination (count) at a time point T6, the idle stop prohibition demand is provided. The TCU receives the idle stop (I/S) prohibition demand and brings the vehicle into an idle driving state at timing (T7) enabling transition to idle driving. At this timing, learning of the opening degree—air quantity characteristic change amount is executed, and when learning and correction ends (T8), the idle stop prohibition demand is cleared to move onto an idle stop. Thereafter, the vehicle is in the stable driving state at time points T9 to T10, but since learning of the air quantity is ended, that is, since the opening degree—air quantity characteristic has been corrected properly, the ΔQAA value is small.

As described above, in the first embodiment, to take advantage of the feature of the hybrid vehicle, in which the stable driving state exists even at the time of the non-idle driving, determination of whether the opening degree—air quantity characteristic has changed significantly (learning requirement determination) is performed in the stable driving state at the time of the non-idle driving, and in a case where learning is required, the vehicle moves onto the idle driving state, and learning of the characteristic change amount is performed. Accordingly, learning is performed only in a case where learning is required, and thus both fuel efficiency and learning accuracy can be improved.

More specifically, in a normal case, in which learning is performed in the idle driving state, learning requirement determination is not performed, and learning is performed every time the vehicle becomes in the idle driving state by accident. Thus, in a case where the vehicle is one that rarely becomes in the idle driving, learning cannot be performed, and determination of whether or not learning is required cannot be performed.

Under such circumstances, by performing the learning requirement determination in the stable driving state at the time of the non-idle driving as above, learning requirement can be determined appropriately even in the vehicle with almost no idle driving state.

By doing so, in the hybrid vehicle, for example, in a case where it is determined that learning is required, the idle stop can be prohibited, the vehicle can move onto the idle driving, and learning can be performed. That is, since transition to the idle driving can be performed only in a scene requiring learning, lowering of fuel efficiency can be restricted to a minimum.

Also, to determine learning requirement, the separation amount between an intake air quantity corresponding to a throttle opening degree at the time stored as the opening degree—air quantity characteristic in the form of, e.g., a map and an actual intake air quantity detected by the air flow sensor is calculated, and the vehicle moves onto learning in a case where the separation amount exceeds the predetermined value (threshold value). Accordingly, learning is performed only in a scene requiring learning, and thus lowering of fuel efficiency can be restricted to a minimum. Also, since the learning requirement determination is performed in a state where the engine is in the stable driving state, that is, in a state where the air quantity is stable, accuracy of the requirement determination is high, and learning can be performed reliably when necessary.

Further, a state in which the intake air quantity does not vary can bring about the most accurate learning requirement determination. Thus, by adopting a configuration in which a state with less variation in the intake air quantity is regarded as the stable driving state, and in which the learning requirement determination is performed in this state, erroneous determination can be prevented.

The air quantity may deviates significantly immediately after transition to the stable driving state due to phase delay of the air intake system, response delay of the air flow sensor. Thus, in a case where the determination threshold value for characteristic change determination is a constant number, erroneous determination may be performed. On the other hand, in a case where determination is started after the intake air quantity is sufficiently stable, it will take time before the determination ends, and in some cases, the vehicle may go out of the engine stable driving state before the determination ends, and the determination itself may not be performed. To perform the determination early during the limited engine stable driving state, the determination is desirably started immediately after transition to the stable driving state. Under such circumstances, by adopting a configuration in which the threshold value changes as time goes by, such as a configuration in which the threshold value is more strict as time goes by, as in the above embodiment, erroneous determination immediately after transition to the stable driving state can be prevented.

In general, the opening degree—air quantity characteristic change caused by deposit adhesion, clogging, and the like is influenced more easily when the throttle opening degree is lower (smaller) and is influenced less easily when the throttle opening degree is higher (larger). Thus, the determination should be performed by changing the threshold value in accordance with the throttle opening degree as in the above embodiment. When the vehicle is in the stable driving state at a high throttle opening degree, the threshold value should be strict, that determination that the characteristic has changed significantly should be enabled even with a small separation amount to enable detection of the characteristic change (determination that learning is required) even at the high throttle opening degree.

Also, in a case where the threshold value is made to be strict at the high throttle opening degree as above, erroneous determination is easy to occur. Thus, by performing determination plural times as in the above embodiment, erroneous determination can be prevented.

Also, by prohibiting the idle stop in a case where it is determined that the characteristic has changed by a characteristic change determining means, the idle driving state can be kept in a scene in which the vehicle should move onto the idle stop (in a state where the engine and the vehicle mounting the same satisfy conditions to perform the idle stop), and learning can be performed as in a conventional manner.

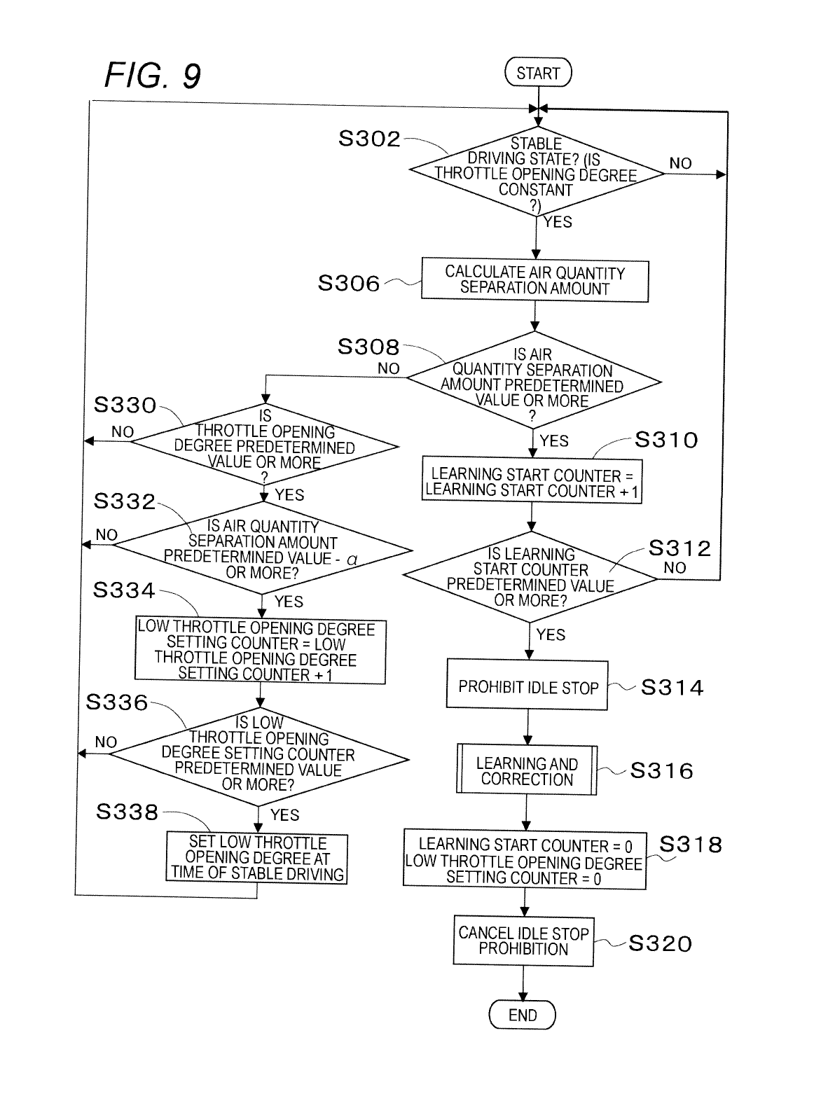

FIG. 9 illustrates a flowchart of a second embodiment, which is different from that of the first embodiment illustrated in FIG. 5.

Illustrated here is a case in which, in a case where it cannot be determined that the opening degree—air quantity characteristic has changed significantly because the throttle opening degree in the stable driving state is large, and because the air quantity separation amount stays in proximity to the threshold value, the throttle opening degree is made to be low when the vehicle becomes in the stable driving state following time in cooperation with the TCU for determination of whether or not the characteristic changes.

S302 to S320 in the figure are basically similar to FIG. 5, and thus only different parts will be described.

While determination of whether or not the throttle opening degree is a predetermined value or less is performed in S104 in FIG. 5, the determination of the throttle opening degree is performed in S330 here. Also, in S318, in addition to processing to clear the learning start counter, processing to clear a low throttle opening degree setting counter is added. The second embodiment includes a first requirement determining means performing learning requirement determination at an accidental throttle opening degree and a second requirement determining means performing learning requirement determination by forcedly lowering a throttle opening degree from the accidental throttle opening degree.

In a case where the air quantity separation amount is a predetermined value or less in S308, the procedure goes to S330. In S330, whether or not the throttle opening degree is a predetermined value or more is determined. In a case of a low throttle opening degree, which is influenced by deposit adhesion, the determination in S308 is regarded as being correct, and the procedure returns to the start without change. In a case of a high throttle opening degree, the procedure goes to S332, and whether or not the characteristic changes is determined again in accordance with the air quantity separation amount. In S332, whether or not the air quantity separation amount is in proximity to the threshold value is determined. In a case where the amount is “predetermined value −□,” which is smaller by □ than the threshold value in S308, or more, it is determined that the opening degree—air quantity characteristic change occurs highly probably, the procedure goes to S334, and a low throttle opening degree setting counter is incremented by one. In a case of NO in S332, the procedure returns to the start, at which time the low throttle opening degree setting counter may be cleared. In this case, a configuration in which processing of S334 and subsequent steps can be executed only when the S332 state is established consecutively is adopted.

Thereafter, in S336, whether or not the low throttle opening degree setting counter is a predetermined value or more is determined. In a case where it is the predetermined value or more, the TCU is informed to set the low throttle opening degree at the time of following stable driving, and the procedure returns to the start. At the time of the following stable driving, the low throttle opening degree will be set. Processing of S302 and subsequent steps is executed. In the case of the stable driving state at the low throttle opening degree, the throttle opening degree is set to the low opening degree actively, and thus erroneous determination is less likely to occur. Thus, in a case of YES determination in S308, S310 and S312 may pass, the procedure may go to S314 to prohibit the idle stop, and the procedure may go to learning. Meanwhile, in a case of NO determination in S308 at the low throttle opening degree, this means that the characteristic does not change, and thus the low throttle opening degree setting counter is cleared, and the demand for setting the low throttle opening degree at the time of the following stable driving is canceled.

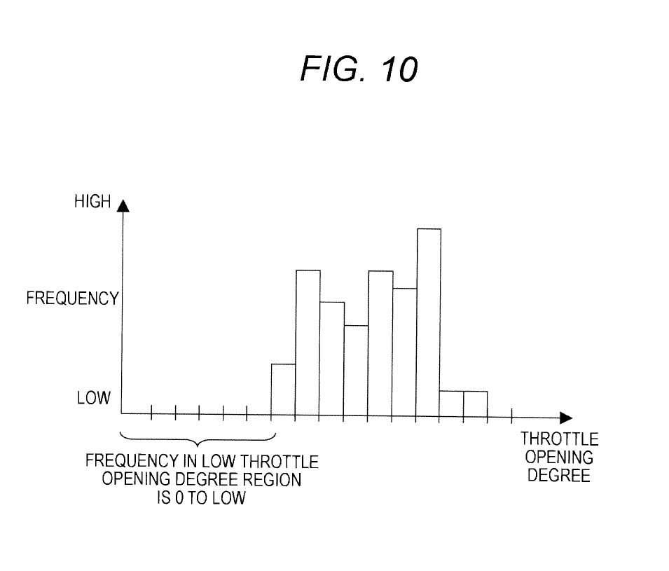

FIG. 10 is a graph illustrating a frequency (count) at which determination of whether or not the opening degree—air quantity characteristic has changed significantly (learning requirement determination) has been performed per throttle opening degree obtained by storing the throttle opening degree at the time every time the learning requirement determination is performed.

In a case where the frequency in a low throttle opening degree region, which is easy to be influenced by deposit adhesion, is zero or low, the stable driving state is forcedly produced in the throttle opening degree region with the frequency of zero or low (the low throttle opening degree is set at the time of a following stable driving state). At the time of the following driving, control is taken so that the vehicle may be in the stable driving state at the low throttle opening degree, at which timing the ECU performs the determination of whether or not the characteristic changes (learning requirement determination). By doing so, even in a driving scene in which the distribution of the low throttle opening degree is small, the characteristic change (learning requirement) can be determined reliably.

Also, in a driving scene in which the stable driving state does not exist, by forcedly producing the stable driving state in a case where the stable driving state does not exist continuously for a predetermined period, the characteristic change (learning requirement) can be determined. At this time, by performing the demand for the low throttle opening degree as well as producing the stable driving state, the characteristic change determination can be performed reliably with one stable driving state.

Meanwhile, in the present embodiment, the learning requirement determination is performed in the stable driving state at the time of the non-idle driving, and in a case where learning is required, the idle stop is prohibited, and the change amount of the opening degree—air quantity characteristic is learned, thus to improve learning accuracy. However, prohibition of the idle stop generates reflection to fuel efficiency.

To restrict the reflection to fuel efficiency, learning may be performed in the stable driving state. In this case, a configuration in which learning is performed by eliminating or considering all the variation causes (VTC, purge, EGR, and the like) in the air intake system is adopted.

### REFERENCE SIGNS LIST

1 engine
4 air intake passage
8 ECU (engine control unit)
13 electronic throttle control valve (ETC)
21 fuel injection valve
22 ignition plug
23 ignition coil
32 air intake valve
34 air exhaust valve
42 throttle sensor
43 air flow sensor
45 crank angle sensor
46 cam angle sensor

1.-11. (canceled)

12. An engine control unit, comprising:
a learning means which learns a characteristic change amount of an engine characteristic such as an opening degree—air quantity characteristic representing relationship between a throttle opening degree and an intake air quantity detected by an air flow sensor to correct a previous characteristic;
a stable driving state determining means which determines whether or not a vehicle is in a stable driving state at time of non-idle driving;
a learning requirement determining means which determines requirement of the learning when it is determined by the means that the vehicle is in the stable driving state; and
a learning moving means which causes the vehicle to move onto the stable driving state such as an idle driving state when it is determined by the determining means that the learning is required to cause the learning means to execute the learning.

13. An engine control unit for a hybrid vehicle including both an engine having an electronic throttle control valve and a motor as travel driving sources, the engine control unit comprising:
a learning means which learns a characteristic change amount of an opening degree—air quantity characteristic representing relationship between an opening degree of the throttle valve and an intake air quantity detected by an air flow sensor stored in a characteristic storing means to correct a previous characteristic stored in the characteristic storing means;
a stable driving state determining means which determines whether or not a vehicle is in a stable driving state at time of non-idle driving;
a learning requirement determining means which determines requirement of the learning when it is determined by the means that the vehicle is in the stable driving state;
a learning moving means which causes the learning means to execute the learning and correction in the stable driving state when it is determined by the learning requirement determining means that the learning is required; and
a throttle valve controlling means which controls the throttle valve with use of the latest opening degree—air quantity characteristic stored in the characteristic storing means,
wherein the learning requirement determining means derives a separation amount between an intake air quantity corresponding to a throttle valve opening degree at present time stored in the characteristic storing means and an actual intake air quantity in the stable driving state and determines requirement of the learning with use of the separation amount and a threshold value set for the separation amount.

14. The engine control unit according to claim 13, wherein the stable driving state determining means determines that the vehicle is in the stable driving state in a case where at least one out of the throttle valve opening degree, engine revolution speed, and the actual intake air quantity is in a predetermined range continuously for a predetermined or longer period at time of the non-idle driving.

15. The engine control unit according to claim 13, wherein the learning requirement determining means changes the threshold value for the separation amount as time goes by.

16. The engine control unit according to claim 13, wherein the learning requirement determining means changes the threshold value for the separation amount in accordance with the throttle valve opening degree.

17. The engine control unit according to claim 13, wherein the learning requirement determining means counts a count the separation amount exceeds the threshold value and determines that the learning is required in a case where a cumulative count thereof exceeds a count for requirement determination.

18. The engine control unit according to claim 13, wherein the learning moving means prohibits an idle stop when it is determined by the learning requirement determining means that the learning is required even in a state in which the engine and a vehicle mounting the engine satisfy conditions to perform the idle stop.

19. The engine control unit according to claim 13, wherein the learning requirement determining means includes a first requirement determining means performing the requirement determination at an accidental throttle opening degree and a second requirement determining means performing the requirement determination by forcedly lowering a throttle opening degree from the accidental opening degree.

20. The engine control unit according to claim 19, wherein the learning requirement determining means performs the requirement determination by the second requirement determining means in cooperation with the motor in a case where the separation amount is less than the threshold value or in proximity to the threshold value.

21. The engine control unit according to claim 13, wherein, in a case where a state in which the vehicle is not in the stable driving state continues for a predetermined or longer period, the stable driving state is adapted to be forcedly produced.

22. The engine control unit according to claim 13, wherein the throttle opening degree at the time is stored every time the learning requirement determination is performed to derive a frequency at which the learning requirement determination has been performed per throttle opening degree, and the stable driving state is forcedly produced in a throttle opening degree region whose frequency is a predetermined value or less.
